(19) United States
(12) Patent Application Publication
(10) Pub. No.: US 2009/0252021 A1
(43) Pub. Date: Oct. 8, 2009

(54) MULTIFOCAL OBJECTIVE LENS AND OPTICAL INFORMATION RECORDING/REPRODUCING DEVICE

(75) Inventors: Satoshi INOUE, Saitama (JP); Shuichi TAKEUCHI, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/419,387

(22) Filed: Apr. 7, 2009

(30) Foreign Application Priority Data
Apr. 8, 2008 (JP) 2008-100252

(51) Int. Cl. G11B 7/00

(52) U.S. Cl. 369/112.23; G9B/7

(57) ABSTRACT

There is provided a multifocal objective lens used for two types of optical discs. The protective layer thicknesses of first and second optical discs t1 and t2 have a relationship: t1<t2. At least one surface of the multifocal objective lens has a first area contributing to converging i-th order diffracted light of the light beam onto the first optical disc and converging j-th order diffracted light onto the second optical disc. The first area includes a step structure of at least a single type of step group giving an optical path length difference, and the step structure is defined by an optical path difference function φ(h):

φ(h)=(P₂h²+P₄h⁴+P₆h⁶+P₈h⁸+P₁₀h¹⁰+P₁₂h¹²)jλ
where P₂, P₄, P₆ . . . represent coefficients of the 2^{nd} order, 4^{th} order, 6^{th} order, respectively, h represents a height from an optical axis, and j is defined by i+1. The multifocal objective lens satisfies a condition:

$$630 < \frac{P 2}{t 2 - t 1} + 110 \times f 1 + 735 \times ( n - 1 ) < 800. \qquad ( 1 )$$

### BACKGROUND OF THE INVENTION

The present invention relates to an objective lens and an optical information recording/reproducing device for recording information to and/or reproducing information from a plurality of types of optical discs of different standards, and particularly to an optical information recording/reproducing device and an objective lens to be mounted in the device to perform information recording or reproducing by using a light beam of the same wavelength with respect to the plurality of types of optical discs.

There exist various standards of optical discs (CD, DVD, etc.) differing in recording density, protective layer thickness, etc. Meanwhile, two types of optical discs (HD DVD (High-Definition DVD), BD (Blu-ray Disc), etc.), having still higher recording density than DVD, have been brought into practical use in recent years to realize still higher information storage capacity.

In consideration of user convenience with such optical discs according to multiple standards, the optical information recording/reproducing devices (more specifically, objective optical systems installed in the devices) of recent years are required to have compatibility with BD and HD DVD having the still higher recoding density. Incidentally, in this specification, the “optical information recording/reproducing devices” include devices for both information reproducing and information recording, devices exclusively for information reproducing, and devices exclusively for information recording. The above “compatibility” means that the optical information recording/reproducing device ensures the information reproducing and/or information recording with no need of component replacement even when the optical disc being used is switched.

In order to provide an optical information recording/reproducing device having the compatibility with optical discs of multiple standards, the device has to be configured to be capable of forming a beam spot suitable for a particular recording density of an optical disc being used, by changing a NA (Numerical Aperture) of an objective optical system used for information reproducing/recording, while also correcting spherical aberration which varies depending on the protective layer thickness changed by switching between optical discs of different standards. Japanese Patent Provisional Publications No. HEI 9-120027 (hereafter, referred to as JP HEI 9-120027A), No. 2007-128654 (hereafter, referred to as JP2007-128654A) and No. 2008-027491 (hereafter, referred to as JP 2008-027491A) disclose optical information recording/reproducing devices configured to form a suitable beam spot on a recording surface of each optical disc in order to attain compatibility with the plurality of types of optical discs of different standards.

An optical information recording/reproducing device disclosed in JP HEI 9-120027A has an objective optical system designed to have substantially the same correction condition for a coma with respect to CD and DVD, and the optical information recording/reproducing device is configured to achieve the compatibility with CD and DVD by performing skew adjustment for the objective optical system to suitably correct a coma caused when each of CD and DVD is used. As described above, the optical information recording/reproducing device disclosed in Japanese Patent Provisional Publication JP HEI 9-120027A is suitable for CD and DVD, however, is unsuitable for using the high recording density optical discs such as BD and HD DVD, since it is not configured to support the high recording density optical discs. Specifically, the optical information recording/reproducing device cannot form a sufficient spot on the recording surface of any high recording density optical disc of BD and HD DVD which are low in tolerance to aberration compared to CD and DVD. Consequently, the configuration disclosed in Japanese Patent Provisional Publication No. 9-120027 cannot attain compatibility between BD and HD DVD.

An optical information recording/reproducing device disclosed in each of JP2007-128654A and JP 2008-027491A has a diffraction structure and an objective lens, and is configured to allow diffracted light, which is diffracted by the diffraction structure, to be converged onto a recording surface of each of the high recording density optical discs BD or HD DVD. As described above, the optical information recording/reproducing device disclosed in JP2007-128654A attains the compatibility with BD and HD DVD. However, there is concern that since paraxial power of a diffracting surface is not optimally set up, optical performance might deteriorate when off-axis light enters into the objective lens, and the tolerance to an assembling error of the objective lens and a laser might become narrow.

### SUMMARY OF THE INVENTION

The present invention is advantageous in that it provides at least one of an objective lens and an optical information recording/reproducing device configured to have compatibility with multiple types of high recording density optical discs of different standards by forming a suitable beam spot on a record surface of each optical disc while suppressing off-axis aberrations, and to achieve easiness of assembling.

According to an aspect of the invention, there is provided a multifocal objective lens used for an optical information recording/reproducing device for recording information to and/or reproducing information from at least two types of optical discs including a first optical disc and a second optical disc having a recording density lower than that of the first optical disc, by using a light beam having a same wavelength of λ for the first and second optical discs. When protective layer thicknesses of the first and second optical discs are defined as t1 (mm) and t2 (mm), respectively, the protective layer thicknesses t1 and t2 have a relationship: t1<t2. At least one surface of the multifocal objective lens has a first area configured to contribute to converging i-th order diffracted light of the light beam onto a recording surface of the first optical disc and converging j-th order diffracted light onto a recording surface of the second optical disc. The first area includes a step structure having a plurality of refractive surface zones concentrically formed about a predetermined axis. The step structure in the first area includes at least a single type of step group giving an optical path length difference with respect to an incident light beam between adjacent ones of the plurality of refractive surface zones.

Further, the step structure is defined by an optical path difference function φ(h):

φ(h)=(P₂h²+P₄h⁴+P₆h⁶+P₈h⁸+P₁₀h¹⁰+P₁₂h ¹²)jλ

where P₂, P₄, P₆ . . . represent coefficients of the 2^{nd} order, 4^{th} order, 6^{th} order, respectively, h represents a height from an optical axis, and j is defined by i+1. The multifocal objective lens satisfies a condition:

$$630 < \frac{P 2}{t 2 - t 1} + 110 \times f 1 + 735 \times ( n - 1 ) < 800 \qquad ( 1 )$$

where n represents an refractive index of the multifocal objective lens with respect to the wavelength λ, and f1 (mm) represents a focal length of the multifocal objective lens with respect to the first optical disc.

Such a configuration makes it possible to form a suitable beam spot for each of the plurality of types of high recording density optical discs of different standards, while suitably correcting the off-axis property for each of the optical discs, and to achieve easiness of assembling.

In at least one aspect, the multifocal objective lens further satisfies a condition:

$$670 < \frac{P 2}{t 2 - t 1} + 110 \times f 1 + 735 \times ( n - 1 ) < 780. \qquad ( 2 )$$

In at least one aspect, the multifocal objective lens further satisfies conditions:

$$\begin{matrix}{N}_{1} - 0.75 < \vert \frac{d \times ( n - 1 )}{λ} \vert < {N}_{1} - 0.15 ; \\ and & ( 3 ) \\ 3.9 \times {10}^{- 04} < λ < 4.3 \times {10}^{- 4} & ( 4 )\end{matrix}$$

where d (mm) represents an average height of the step group, and N₁ represents a natural number.

In at least one aspect, the multifocal objective lens further satisfies a condition:

$${N}_{1} - 0.70 < \vert \frac{d \times ( n - 1 )}{λ} \vert < {N}_{1} - 0.40 . \qquad ( 5 )$$

In at least one aspect, the multifocal objective lens further satisfies a condition:

1.50≦n≦1.66 (6).

In at least one aspect, an optical disc side surface of the multifocal objective lens is configured such that a sign of curvature changes within an effective diameter.

In at least one aspect, the at least one surface of the multifocal objective lens has a second area located outside the first area. In this case, the second area is configured to contribute to converging the light beam onto the recording surface of the first optical disc and not to contribute to converging the light beam onto the recording surface of the second optical disc.

In at least one aspect, the at least one surface of the multifocal objective lens is configured to satisfy a condition:

0.2×10⁻³<d1−d2<1.0×10⁻³ (7)

where d1 (mm) represents a height of a step formed at an outermost part in the first area, and d2 (mm) represents a height of a step formed at an innermost part in the second area 11b.

In at least one aspect, the second area is formed to be a refractive surface.

According to another aspect of the invention, there is provided an optical information recording/reproducing device for recording information to and/or reproducing information from at least two types of optical discs including a first optical disc and a second optical disc having a recording density lower than that of the first optical disc, by using a light beam having a same wavelength of λ for the first and second optical discs. When protective layer thicknesses of the first and second optical discs are defined as t1 (mm) and t2 (mm), respectively, the protective layer thicknesses t1 and t2 have a relationship: t1<t2. The optical information recording/reproducing device has one of the above described multifocal objective lens.

Such a configuration makes it possible to form a suitable beam spot for each of the plurality of types of high recording density optical discs of different standards, while suitably correcting the off-axis property for each of the optical discs, and to achieve easiness of assembling.

### BRIEF DESCRIPTION OF THE ACCOMPANYING DRAWINGS

FIG. 1 is a diagram showing an outline configuration of an optical information recording/reproducing device provided with an objective lens according to an embodiment of the present invention and each optical disc.

FIG. 2 is an enlarged view showing the vicinity of the objective lens according to the embodiment of the invention.

FIG. 3A is a graph showing the spherical aberration SA and the “offence against the sine condition” SC caused when a first optical disc is used in a design standard condition of the optical information recording/reproducing device according to a first example, and FIG. 3B is a graph showing the spherical aberration SA and the offence against sine condition SC caused when a second optical disc is used in the design standard condition of the optical information recording/reproducing device according to the first example.

FIG. 4A is a graph showing spherical aberration SA and the “offence against the sine condition” SC occurring in use of the first optical disc in a design standard condition of an optical information recording/reproducing device according to a comparative example, and FIG. 4B is a graph showing the spherical aberration SA and the “offence against the sine condition” SC occurring in use of the second optical disc in the design standard condition of the optical information recording/reproducing device according to the comparative example.

FIG. 5A is a graph showing the spherical aberration SA and the “offence against the sine condition” SC caused when the first optical disc is used in a design standard condition of the optical information recording/reproducing device according to a second example, and FIG. 5B is a graph showing the spherical aberration SA and the “offence against sine condition” SC caused when the second optical disc is used in the design standard condition of the optical information recording/reproducing device according to the second example.

FIG. 6A is a graph showing the spherical aberration SA and the “offence against the sine condition” SC caused when the first optical disc is used in a design standard condition of the optical information recording/reproducing device according to a third example, and FIG. 6B is a graph showing the spherical aberration SA and the “offence against sine condition” SC caused when the second optical disc is used in the design standard condition of the optical information recording/reproducing device according to the third example.

FIG. 7A is a graph showing the spherical aberration SA and the “offence against the sine condition” SC caused when the first optical disc is used in a design standard condition of the optical information recording/reproducing device according to a fourth example, and FIG. 7B is a graph showing the spherical aberration SA and the “offence against sine condition” SC caused when the second optical disc is used in the design standard condition of the optical information recording/reproducing device according to the fourth example.

FIG. 8 is a cross sectional view of the objective lens illustrating an annular zone structure formed thereon.

### DETAILED DESCRIPTION OF THE EMBODIMENTS

Hereinafter, embodiments according to the invention are described with reference to the accompanying drawings.

Hereinafter, an objective lens and an optical information recording/reproducing device in which the objective lens is mounted according to an embodiment of the present invention will be described. The optical information recording/reproducing device according to the embodiment has compatibility with optical discs of two different types of standards respectively having different protective layer thickness and recording densities. In this embodiment, the optical discs of two different types of standards are BD standard and HD DVD standard optical discs. Hereinafter, for convenience of explanation, an optical disc with a relatively high recording density such as a BD standard disc is referred to as an optical disc D1, and an optical disc with a relatively low recording density such as an HD DVD standard disc is referred to as an optical disc D2.

When the protective layer thickness of the optical discs D1 and D2 are respectively defined as t1 and t2, the protective layer thicknesses t1 and t2 has the following relationship.

t1<t2

In this embodiment, the protective layer thickness t1 of the optical disc D1 is approximately 0.1 mm, and the protective layer thickness t2 of the optical disc D2 is approximately 0.6 mm.

When performing information recording or reproducing for each of the optical discs D1 and D2, the required numerical aperture (NA) has to be varied so that a beam spot corresponding to the recording density of the optical disc being used can be obtained. When the optimal design numerical apertures required for the information recording or reproducing for the optical discs D1 and D2 are respectively defined as NA 1 and NA 2, NA1 and NA2 have the following relationship.

NA1>NA2

Since a required beam spot diameter for the information recording or reproducing for the optical disc D1 is smaller than a required beam spot diameter for information recording or reproducing for the optical disc D2, a required NA for the information recording or reproducing for the optical disc D1 becomes larger than that for the information recording or reproducing for the optical disc D2.

As described above, when optical discs respectively different in required NA are used, generally laser beams of different wavelengths are used so that desired beam spot diameters can be obtained respectively. However, laser beams of the same wavelength, specifically so-called blue laser beams of approximately 405 nm as the design wavelength are used for the optical discs D1 and D2. As described below, the optical information recording/reproducing device according to the embodiment is configured to form a suitable beam spot on a recording surface of each of the optical discs D1 and D2 for which the laser beam of the same wavelength is used regardless of the fact that the optical discs D1 and D2 have different standards.

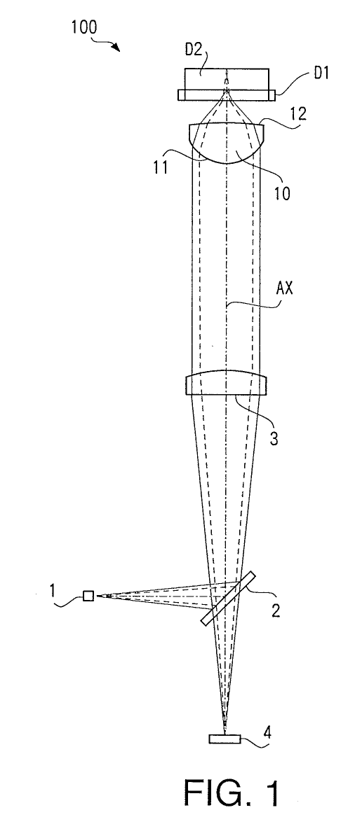

FIG. 1 is a schematic diagram showing an outline configuration of an optical information recording/reproducing device 100 having an objective lens 10 according to the embodiment. As shown in FIG. 1, the optical information recording/reproducing device 100 includes a light source 1 configured to emit a blue laser beam, a half mirror 2, a collimator lens 3, a photoreceptor 4, and the objective lens 10. A chain line shown in FIG. 1 is a reference axis AX of the optical information recording/reproducing device 100. A solid line shows an incident light beam to the optical disc D1 or a return light beam therefrom, and a dotted line shows an incident light beam to the optical disc D2 or a return light beam therefrom. Typically, the optical axis of the objective lens 10 corresponds to the reference axis AX. However, a condition that the optical axis of the objective lens 10 shifts from the reference axis AX could occur caused by a tracking operation and the like.

Each of the optical discs D1 and D2 has a protective layer and a recording surface (not shown). Practically, the recording surface of each of the optical discs D1 and D2 is sandwiched between the protective layer and a substrate layer or a label layer. When the information recording or reproducing is performed, the optical disc is set and rotated on a turntable (not shown).

As shown in FIG. 1, a laser beam emitted from the light source 1 is deflected by the half mirror 2 and converted into a collimated beam through the collimator lens 3, and then is incident on a first surface 11 of the objective lens 10. The laser beam entered into the first surface 11 exits from a second surface 12 of the objective lens 10, and is converged in the vicinity of the recording surface of the optical disc D1 or the optical disc D2 being used. The laser beam reflected from the recording surface of the optical disc D1 or the optical disc D2 returns along the same optical path as entering, passes through the half mirror 2, and is received by the photoreceptor 4.

As described above, the optical information recording/reproducing device 100 adopts a configuration in which a collimated beam is incident on the objective lens 10. Therefore, even when the objective lens 10 shifts by a minute amount for a tracking operation (i.e., a so-called tracking shift) in a direction perpendicular to the optical axis, off-axis aberrations such as a coma does not occur in the optical information recording/reproducing device 100. However, practically, occurrence of an off-axis aberration cannot be suppressed completely because of errors such as decentering or an assembling error of a lens element. Therefore, it is required to further enhance the performance for off-axis light with respect to the HD DVD while maintaining the suitable performance for BD which requires a higher NA and has a higher recording density. In other words, it is required to suppress the sensitivity of the off-axis property of BD with respect to errors such as decentering or an assembling error of the lens element while also suppressing the sensitivity of the off-axis property of HD DVD with respect to the errors.

As described above, the protective layers of the optical discs D1 and D2 are respectively 0.1 mm and 0.6 mm in thickness, which are different from each other. Therefore, if the optical information recording/reproducing device 100 is designed optimally for the optical disc D1, a spherical aberration is caused when the optical disc D2 is used due to the difference of the protective layer thickness. Therefore, such design in which the optical information recording/reproducing device 100 is optimized for the optical disc D1 is not suitable for use of the optical disc D2.

Likewise, if the optical information recording/reproducing device 100 is designed optimally for the optical disc D2, a spherical aberration is caused when the optical disc D1 is used due to the difference of the protective layer thickness. Therefore, such design in which the optical information recording/reproducing device 100 is optimized for the optical disc D2 is not suitable for use of the optical disc D1.

In order to attain compatibility with the optical discs D1 and D2, i.e., in order to ensure the information recording or reproducing for both of the optical discs D1 and D2, it is required to suitably correct the spherical aberration for each of the optical discs D1 and D2.

To meet such a requirement, the optical information recording/reproducing device 100 is configured such that the objective lens 10 achieves the suitable property for BD having the higher recording density and the suitable property for HD. In order to achieve such a property, the optical information recording/reproducing device 100 is configured as follows. Hereinafter, the objective lens 10 will be described in detail.

Both of the first surface 11 and the second surface 12 of the objective lens 10 are aspherical surfaces.

A shape of an aspherical surface is expressed by a following equation:

$$X ( h ) = \frac{{ch}^{2}}{1 + \sqrt{1 - ( 1 + K ) {c}^{2} {h}^{2}}} + {\sum }_{i = 2} {A}_{2 i} {h}^{2 i}$$

where, X(h) represents a SAG amount which is a distance between a point on the aspherical surface at a height of h from the optical axis and a plane tangential to the aspherical surface at the optical axis, symbol c represents curvature (1/r) on the optical axis, K is a conical coefficient, and A₂ᵢ (i: integer≧2) represents an aspherical coefficient of an even order larger than or equal to the fourth order.

By forming each of the first and second surfaces 11 and 12 to be an aspherical surface, it becomes possible to properly control the spherical aberration.

In this embodiment, the objective lens 10 is a molded product made of a single material (e.g., synthetic resin). Therefore, the objective lens 10 is excellent in producing easiness, mass productivity, cost aspect, and the like.

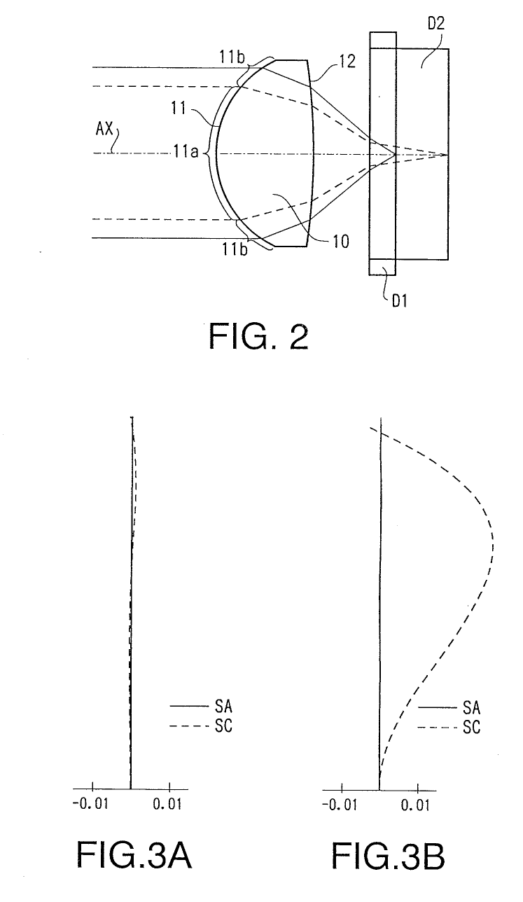

FIG. 2 shows an enlarged view of a configuration in the vicinity of the objective lens 10. As shown in FIG. 2, the first surface 11 of the objective lens 10 has a first area 11a including the optical axis AX, and a second area 11b which is formed on the outside of the first area 11a. In these areas, at least the first area 11a is provided with an annular zone structure. The annular zone structure is provided with a plurality of refractive surface zones (annular zones) concentrically formed about the optical axis (corresponding to the reference axis AX when the tracking operation is not executed). The refractive surface zones are divided by minute steps, each of which extends substantially in parallel with the direction of the optical axis.

By providing the annular zone structure on the first surface 11 and not on the second surface 12, it becomes possible to increase the minimum annular zone width and thereby to suppress loss of the light amount by each step portion of the annular zone structure with respect to an effective beam width. The configuration of the objective lens 10 has further advantages that problems such as contamination of the second surface 12 by dust, and abrasion of the annular zone structure by rubbing of the objective lens 10 using a lens cleaner can be prevented.

Each step of the annular zone structure is designed to cause a predetermined optical path length difference between a light beam passing through the inside of a boundary between adjacent refractive surface zones and a light beam passing through the outside of the boundary. Such a structure can be generally expressed as a diffraction structure. The annular zone structure formed such that the predetermined optical path length difference is n-fold (n: integer) of a particular wavelength α can be expressed as an n-th order diffraction structure having a blazed wavelength α. A diffraction order at which the diffraction efficiency of the diffracted light is maximized when the light beam having a certain wavelength β passes through the diffraction structure is an integer m which is nearest to a value obtained by dividing the wavelength β by the optical path length difference given to the light beam having the wavelength β.

Additionally, occurrence of an optical path length difference between the light beam passing through the inside of the boundary between adjacent refracting surface zones and the light beam passing through the outside of the boundary can be construed as a shift of mutual phases affected by the step of the annular zone structure. Therefore, the annular zone structure may be referred to as a structure for shifting the phase of the incident light beam, that is, a phase shift structure.

The annular zone structure can be represented by an optical path difference function φ(h). The optical path difference function φ(h) is a function in which performance of the objective lens 10 as a diffractive lens is expressed in a form of an additional optical path length at the height h from the optical axis, and which defines a setting position of each step in the annular zone structure. More specifically, an optical path difference function φ(h) can be expressed by an equation:

φ(h)=(P₂h²+P₄h⁴+P₆h⁶+P₈h⁸+P₁₀h¹⁰+P₁₂h¹²)jλ

where P₂, P₄, P₆ . . . represent coefficients of the 2^{nd} order, 4^{th} order, 6^{th} order, respectively, h represents a height from the optical axis, λ represents a design wavelength of an incident laser beam, and j represents a diffraction order at which the diffraction efficiency is maximized when the optical disc D2 is used.

The objective lens 10 is designed to satisfy the following condition (1); where a diffraction order at which the diffraction efficiency is maximized when the optical disc D1 is used is i-th order, a diffraction order at which the diffraction efficiency is maximized when the optical disc D2 is used is j-th order, a refractive index with respect to the wavelength λ is defined as n, a focal length for the optical disc D1 is defined as f1, and i (i is a nonnegative integer) is defined as a value expressed by j−1. In this regard, the refractive index n is assumed to be 1.50 to 1.66 (condition (6)).

$$630 < \frac{P 2}{t 2 - t 1} + 110 \times f 1 + 735 \times ( n - 1 ) < 800 \qquad ( 1 )$$

By satisfying the condition (1), it becomes possible to form a suitable beam spot on the recording surface of each of the optical discs D1 and D2 while correcting the spherical aberration, and to achieving the suitable off-axis property for the optical disc D2 while suitably correcting the off-axis property for the optical disc D1. That is, it becomes possible to ensure the information recording or reproducing for the optical disc D1 with a high degree of accuracy and to ensure the information recording or reproducing for the optical disc D2 with a high degree of accuracy.

By configuring the objective lens 10 to achieve the above described suitable off-axis property, it becomes possible to eliminate the need, for example, for performing skew adjustment for the objective lens 10. Therefore, advantages for improvement in producing easiness, shortening of the lead time, reducing cost, and the like can be achieved.

In the expression of the condition (1), a certain value is assigned to the optical path difference function coefficient P₂ of the optical path difference function φ(h) (i.e., a term having effects on a paraxial beam), and t1, t2, f1, n are defined as constants. Further, an amount of off-axis aberration caused in use of the optical disc D2 is calculated for each value obtained by calculation of the expression according to the condition (1).

Then, to find an approximate expression, each of the calculation result is plotted on a biaxial graph, where x-axis represents values of the expression according to the condition (1), and y-axis represents the amount of off-axis aberration. Consequently, a quadric approximate curve (y=Bx²+C), where the minimum value (extreme value) is within the range of the condition (1) can be obtained. According to the quadric approximate curve as described above, it is recognized that increase of the amount of off-axis aberrations is small even if an optical path difference function coefficient P₂ is increased or decreased in the proximity of the extreme value (optimal value). Therefore, an excellent off-axis property can be attained when the objective lens 10 is configured to satisfy the condition (1).

The amount of off-axis aberration during use of the optical disc D2 varies in a form of a quadric function when the optical path difference function coefficient P₂ is varied as shown in the above-described quadric approximate curve. Since the minimum extreme value is within the range defined by the condition (1), the off-axis aberration increases more significantly as the optical path difference function coefficient P₂ goes farther away from the optimal value. Accordingly, when the optical path difference function coefficient P₂ goes largely away from the optimal value, the value of the expression according to the condition (1) reaches to the upper limit value, and further comes to more than the upper limit value, the amount of off-axis aberration rapidly increases. Likewise, when the value of the expression according to the condition (1) reaches to the lower limit value, and further comes to less than the limit value, the amount of off-axis aberration rapidly increases. That means, when the value of the expression according to the condition (1) becomes larger than or equal to the upper limit value of the condition (1), or becomes lower than or equal to the lower limit value of the condition (1), the off-axis property rapidly deteriorates, and therefore it becomes impossible to ensure the information recording or reproducing for the optical disc D2 with a high degree of accuracy.

The objective lens 10 may be configured to satisfy the following condition (2). By designing the objective lens 10 to satisfy the following condition (2), a beam spot where the spherical aberration is suitably corrected can be formed onto the recording surface of each of the optical discs D1 and D2, and the off-axis property in use of the optical disc D2 can be further suitably improved.

$$670 < \frac{P 2}{t 2 - t 1} + 110 \times f 1 + 735 \times ( n - 1 ) < 780 \qquad ( 2 )$$

By satisfying the condition (2), further assurance of a proper operation in use of the optical disc D2 can be achieved. As additional advantages, it becomes possible to increase the tolerance with respect to an assembling error of the objective lens 10, and to suppress the density of steps on the annular zone structure to a predetermined range and thereby to prevent decrease of the yield due to an excessively high degree of difficulty of molding.

The objective lens 10 may be designed to satisfy the following conditions (3) and (4); where an average height of the respective level differences of the annular zone structure is defined as d (mm), and N₁ is a natural number.

$$\begin{matrix}{N}_{1} - 0.75 < \vert \frac{d \times ( n - 1 )}{λ} \vert < {N}_{1} - 0.15 & ( 3 ) \\ 3.9 \times {10}^{- 04} < λ < 4.2 \times {10}^{- 4} & ( 4 )\end{matrix}$$

By satisfying the conditions (3) and (4), the objective lens 10 can secure a high use efficiency of light for each of the optical discs D1 and D2, and therefore it becomes possible to ensure the information recording or reproducing with a high degree of accuracy for each of the optical discs D1 and D2.

When the value of the expression according to the condition (3) gets lower than or equal to the lower limit value of the condition (3) (i.e., when the blazed wavelength of the annular zone structure is small), the use efficiency of light with respect to the optical disc D1 becomes high while the use efficiency of light with respect to the optical disc D2 is lowered, whereby the information recording or reproducing for the optical disc D2 with a high degree of accuracy cannot be ensured. By contrast, when the value of the expression according to the condition (3) becomes higher than equal to the upper limit value of the condition (3) (i.e., the blazed wavelength of the annular zone structure is large), the use efficiency of light with respect to the optical disc D2 becomes high while the use efficiency of light with respect to the optical disc D1 is lowered, whereby the information recording or reproducing for the optical disc D1 with a high degree of accuracy cannot be ensured.

The objective lens 10 may be configured to satisfy the following condition (5). By designing the objective lens 10 so as to satisfy the following condition (5), the use efficiency of light can be maintained at a higher level for each of the optical discs D1 and D2.

$${N}_{1} - 0.70 < \vert \frac{d \times ( n - 1 )}{λ} \vert < {N}_{1} - 0.40 . \qquad ( 5 )$$

By satisfying the condition (5), further assurance of a proper operation in use of each of the optical discs D1 and D2 can be achieved. Additionally, even when a light amount of the light source 1 decreases with time, the information recording or reproducing for each of the optical discs D1 and D2 can be performed, and therefore the product life span of the optical information recording/reproducing device 100 can be extended. Considering stability of molding, the actual use efficiency of light and a fact that N1 is a factor for defining the height of each step, it is preferable that N1 takes a relatively small value.

As described above, the first area 11a is configured as a common area contributing to convergence of the laser beam onto the recording surface of each of the optical discs D1 and D2. On the other hand, the second area 11b is configured to be a area dedicated for the optical disc D1. That is, the second area 11b is configured to contribute to convergence of the laser beam onto the recording surface of the optical disc D1, and not to contribute to convergence of the laser beam onto the recording surface of the optical disc D2. In other words, the second area 11b has a numerical aperture limiting function with respect to the laser beam to be converged on the recording surface of the optical disc D2. According to the embodiment, a required NA in use of the optical disc D1 having a higher recording density is secured by providing the dedicated area for the optical disc D1 in an outer part on the first surface 11.

When the annular zone structure of the first area 11a is formed such that the diffraction order at which the diffraction efficiency is maximized for the optical disc D1 is the 0-th order, the second area 11b is formed to be an aspherical surface (refracting surface) not having the annular zone structure. On the other hand, when the annular zone structure of the first area 11a is formed such that the diffraction order at which the diffraction efficiency is maximized for the optical disc D1 is the first order or a higher order, the annular zone structure in the second area 11b is configured to have a step group giving one type of optical path length difference to the incident laser beam as in the case of the first area 11a.

The objective lens 10 may be designed to satisfy the following condition (7):

0.2×10⁻³<d1−d2<1.0×10⁻³ (7),

where the height of a step at the outermost part in the first area 11a is defined as d1 (mm), and the height of a step at the innermost part in the second area 11b is defined as d2 (mm). In this regard, when the second area 11b is an aspherical surface not having the annular zone structure, d2 is 0.

By forming the annular zone structure on the first surface 11 so as to satisfy the condition (7), the objective lens 10 is able to secure a high use efficiency of light for each of the optical discs D1 and D2. Therefore, it becomes possible to ensure the information recording or reproducing with a high degree of accuracy for each of the optical discs D1 and D2. When a value of the expression according to the condition (7) gets lower than or equal to the lower limit value of the condition (7), (i.e., when the difference between the height of the step at the periphery of the first area 11a and the height of the step at the inner side of the second area 11b is small), the numerical aperture limiting function of the second area 11b does not work sufficiently, and the use efficiency of light in use of the optical disc D1 decreases. When a value of the expression according to the condition (7) gets larger than or equal to the upper limit value of the condition (7) (i.e., when the difference between the height of the step at the periphery of the first area 11a and the height of the step at the inner side of the second area 11b is large), the use efficiency of light in use of the optical disc D1 decreases.

FIG. 8 is a conceptual illustration of the annular zone structure formed on the first surface 11 of the objective lens 10. That is, FIG. 8 is a cross sectional view of the objective lens 10 illustrating the annular zone structure formed on the first surface 11 of the objective lens 10. In FIG. 8, the first and second areas 11a and 11b are illustrated. Since FIG. 8 aims to provide a conceptual diagram of an annular zone structure, in FIG. 8 the annular zone structure is illustrated such that each area is formed of a single type of step.

Hereinafter, four concrete examples of the optical information recording/reproducing device 100 in which the objective lens 10 is mounted will be explained. The optical information recording/reproducing device 100 according to each of the four examples has an outline configuration shown in FIG. 1.

### First Example

Specifications of the objective lens 10 to be mounted on the optical information recording/reproducing device 100 according to a first example, specifically, a wavelength of the light beam to be used for the recording or reproducing for each optical disc, a focal length of the objective lens 10 in use of each optical disc, NA, and a magnification are as shown in the following Table 1. In this regard, a working wavelength, that is, a laser beam emitted from the light source 1 is within the range of the above condition (4) even taking mode hopping into consideration. In each of the first to fourth examples, the presented numerical configuration is limited to optical elements on the rear side of the objective lens 10 in order to clarify characteristics of the present invention, in short, aspects of the objective lens 10. The description of each Table in the first example may be applied also to each Table of other specific examples.

TABLE 1

| | Optical Disc D1 | Optical Disc D2 |
|---|---|---|
| Wavelength (nm) | 405 | 405 |
| Focal Length (mm) | 1.65 | 1.76 |
| NA | 0.85 | 0.65 |
| Magnification | 0.000 | 0.000 |

As can be seen from the values of magnification shown in Table 1, the optical information recording/reproducing device 100 is designed that a collimated beam is incident on the objective lens 10 for each of the optical discs D1 and D2. Therefore, occurrence of an off-axis aberration at the time of a tracking shift can be avoided efficiently. Specific numerical configurations of the optical information recording/reproducing device 100 in use of the respective optical discs D1 and D2 are shown in Table 2 and 3.

TABLE 2

| Surface No. | r | d | n(405 nm) | |
|---|---|---|---|---|
| 1(1^{st} Area) | 1.096 | 2.00 | 1.56023 | Objective Lens |
| 1(2^{nd} Area) | 1.096 | | | |
| 2 | −2.035 | 0.52 | | |
| 3 | ∞ | 0.0875 | 1.62231 | Optical Disc D1 |
| 4 | ∞ | — | | |

TABLE 3

| Surface No. | r | d | n(405 nm) | |
|---|---|---|---|---|
| 1(1^{st} Area) | 1.096 | 2.00 | 1.56023 | Objective Lens |
| 1(2^{nd} Area) | 1.096 | | | |
| 2 | −2.035 | 0.36 | | |
| 3 | ∞ | 0.60 | 1.62231 | Optical Disc D2 |
| 4 | ∞ | — | | |

In Table 2 and 3, surface numbers #1 and #2 represent the first surface 11 and the second surface 12 of the objective lens 10, respectively, and surface numbers #3 and #4 represent the protective layer and the recording layer of the optical discs, respectively. Further, the specific numerical configuration of the surface number #1 (the first surface 11) is shown as the first area 11a and the second area 11b separately. In Tables 2 and 3 (and in the following similar Tables), “r” is a radius of curvature (unit: mm) of each surface of the optical elements, “d” is an optical element thickness or a distance between each optical element (unit: mm), “n” is a refractive index of each optical element at the time of recording or reproducing of information. In this regard, r of an aspherical element represents a radius of curvature on the optical axis.

The first surface 11 (surface number #1) and the second surface 12 (surface number #2) of the objective lens 10 are aspherical surfaces. The aspherical shape of each surface is optimally designed for the optical disc D1. The conical coefficient K and aspherical coefficients A₂ᵢ which define the aspherical shape of each surface are shown in Table 4. In this regard, the symbol E in each Table denotes power of 10 as a radix with a number of the right side of E as an exponent.

TABLE 4

| | Surface No. | | |
|---|---|---|---|
| | 1(1^{st} Area) | 1(2^{nd} Area) | 2 |
| K | −1.8000 | −1.8000 | −33.5000 |
| A4 | 1.2630E−01 | 1.2630E−01 | 3.0848E−01 |
| A6 | −1.7428E−02 | −1.7428E−02 | −7.1283E−01 |
| A8 | 2.0657E−02 | 2.0657E−02 | 1.0742E+00 |
| A10 | −1.1496E−02 | −1.1496E−02 | −1.0922E+00 |
| A12 | 1.8557E−03 | 1.8557E−03 | 8.6905E−01 |
| A14 | 4.2731E−03 | 4.2731E−03 | −7.8711E−01 |
| A16 | −1.4274E−03 | −1.4274E−03 | 7.0166E−01 |
| A18 | −1.1015E−03 | −1.1015E−03 | −3.9340E−01 |
| A20 | 1.7756E−04 | 1.7756E−04 | 9.8435E−02 |
| A22 | 3.7336E−04 | 3.7336E−04 | 1.4347E−04 |
| A24 | −9.0360E−05 | −9.0360E−05 | −2.7705E−03 |
| A26 | −1.3057E−05 | −1.3057E−05 | 0.0000E+00 |

The optical path difference function coefficients Pₙ (n is a positive even number) of the optical path difference function φ(h) for defining the annular zone structure of each area on the first surface 11 are shown in Table 5.

TABLE 5

Surface No.

| | 1(1^{st} Area) | 1(2^{nd} Area) |
|---|---|---|
| P2 | 7.0000E+01 | 0.0000E+00 |
| P4 | −5.0229E+00 | 0.0000E+00 |
| P6 | 2.9645E+00 | 0.0000E+00 |
| P8 | −9.4293E−01 | 0.0000E+00 |
| P10 | 6.5271E−01 | 0.0000E+00 |
| P12 | −3.5588E−01 | 0.0000E+00 |

In the first example, as shown in Table 5, the annular zone structure is provided only in the first area 11a of the first surface 11, and the second area 11b has an aspherical shape without the annular zone structure. The annular zone structure in the first area 11a has steps which are defined by one type of optical path difference function, and is designed such that the diffraction order at which the diffraction efficiency is maximized for the optical disc D1 is the 0-th order (i=0), and the diffraction order at which the diffraction efficiency is maximized for the optical disc D2 is the first order (j=1). That is, the first example is designed to converge the 0-th order diffracted light onto the recording surface of the optical disc D1, and to converge the first order diffracted light onto the recording surface of the optical disc D2. As described above, since the aspherical surface of the first surface 11 is optimally designed for the optical disc D1, the laser beam entered in the second area 11b is converged onto the recording surface of the optical disc D1 by an aspherical surface effect. By forming the second area 11b as a refracting surface not having steps, the light amount loss which is caused by the steps does not occur, whereby the use efficiency of light with respect to the optical disc D1 further increases.

In the first example, a value of the expression according to the condition (1) and the condition (2) are 730, whereby both of the conditions (1) and (2) are satisfied. By satisfying the conditions (1) and (2), the objective lens 10 according to the first example is able to form a beam spot where the spherical aberration is suitably corrected onto the recording surface of each of the optical discs D1 and D2, while achieving the excellent off-axis property in use of the optical disc D2. Therefore, it becomes possible to ensure the information recording or reproducing with a high degree of accuracy for each of the optical discs D1 and D2 which have low tolerance to aberration.

In the first example, a value of the expression according to each of the conditions (3) and (5) is 0.43, and therefore both of the conditions (3) and (5) are satisfied. By satisfying the conditions (3) and (5), the objective lens 10 according to the first example is able to secure a high use efficiency of light for each of the optical discs D1 and D2. Consequently, it becomes possible to ensure the information recording or reproducing with a high degree of accuracy for each of the optical discs D1 and D2.

In the first example, a value of the expression according to the condition (7) is 0.40, and therefore the condition (7) is satisfied. By satisfying the condition (7), the objective lens 10 is able to secure a high use efficiency of light for each of the optical discs D1 and D2. Therefore, further assurance of a proper operation can be achieved for each of the optical discs D1 and D2.

FIG. 3A is a graph showing the spherical aberration SA and the “offence against the sine condition” SC caused when the optical disc D1 is used in a design standard condition of the optical information recording/reproducing device 100 according to the first example. FIG. 3B is a graph showing the spherical aberration SA and the offence against sine condition SC caused when the optical disc D2 is used in the design standard condition of the optical information recording/reproducing device 100 according to the first example. In each graph of FIGS. 3A and 3B, the vertical axis represents entrance pupil coordinates, and the horizontal axis represents the spherical aberration amount (mm) or the offence against the sine condition. In each of the graphs of FIGS. 3A and 3B, a solid line shows the spherical aberration SA at the design wavelength, and a dotted line shows the offence against the sine condition SC, respectively. The definitions of the graphs and lines shown in each of the Figs. A and B are the same as that in the graphs being presented in the next comparative example and the subsequent each Example described below.

According to FIGS. 3A and 3B, it is understood that the spherical aberration is suitably corrected and the suitable off-axis property is achieved for each of the optical discs D1 and D2. Therefore, according to the first example, it is possible to ensure the information recording and reproducing with a high degree of accuracy for each of the optical discs D1 and D2.

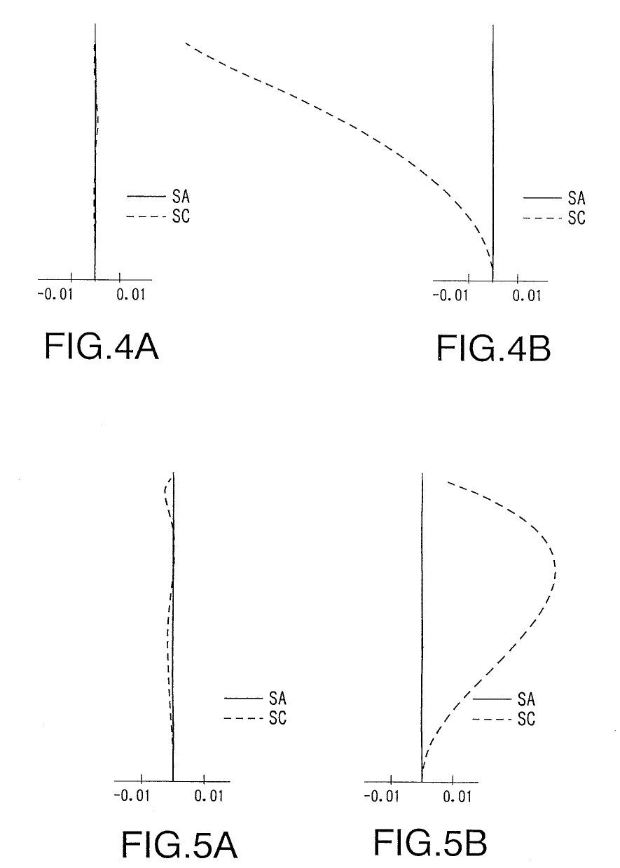

FIG. 4A is a graph showing spherical aberration SA and the “offence against the sine condition” SC occurring in use of the optical disc D1 in a design standard condition of an optical information recording/reproducing device according to a comparative example. FIG. 4B is a graph showing the spherical aberration SA and the “offence against the sine condition” SC occurring in use of the optical disc D2 in the design standard condition of the optical information recording/reproducing device according to the comparative example. It is assumed that the optical information recording/reproducing device according to the comparative example is configured to have substantially the same configuration as the first example except that the optical path difference function coefficient P₂ is −50 (it is 70 in the first example). In the comparative example, a value of the expression according to condition (1) becomes 495. Therefore, the comparative example does not satisfy the condition (1).

In comparison between respective graphs in FIG. 3 and FIG. 4, it is understood that the “offence against the sine condition” SC largely occurs on the underside when the optical disc D2 is used in the comparative example, while the sine condition in use of the optical disc D2 is substantially satisfied in the first example. This means that the information recording or reproducing for the optical disc D2 with a high degree of accuracy is not ensured in the comparative example, while the off-axis property in use of the optical disc D2 is largely improved in the first example compared to the comparative example, and the information recording or reproducing for the optical disc D2 with a high degree of accuracy is ensured in the first example.

Further, in the first example, the use efficiency of light in use of the optical disc D1 is 68%, and the use efficiency of light in use of the optical disc D2 is 30%. These values of the use efficiency of light are enough for ensuring the information recording or reproducing for each of the optical discs D1 and D2 with a high degree of accuracy. Therefore, it is understood that a high use efficiency of light is achieved in the first example. As described above, the objective lens 10 according to the first example exhibits an excellent optical property for the information recording or reproducing for each of the optical discs D1 and D2.

### Second Example

Hereafter, a second example is explained. The specifications of the objective lens 10 according to the second example are shown in Table 6, the specific numerical configurations in use of the respective optical discs D1 and D2 are respectively shown in Tables 7 and 8, and the respective coefficients which define the aspherical shape are shown in Table 9.

TABLE 6

| | Optical Disc D1 | Optical Disc D2 |
|---|---|---|
| Wavelength λ (nm) | 405 | 405 |
| Focal Length f (mm) | 1.53 | 1.66 |
| NA | 0.85 | 0.65 |
| Magnification | 0.000 | 0.000 |

TABLE 7

| Surface No. | r | d | n(405 nm) | |
|---|---|---|---|---|
| 1(1^{st} Area) | 1.018 | 1.86 | 1.56023 | Objective Lens |
| 1(2^{nd} Area) | 1.018 | | | |
| 2 | −1.866 | 0.47 | | |
| 3 | ∞ | 0.0875 | 1.62231 | Optical Disc D1 |
| 4 | ∞ | — | | |

TABLE 8

| Surface No. | r | d | n(405 nm) | |
|---|---|---|---|---|
| 1(1^{st} Area) | 1.018 | 1.86 | 1.56023 | Objective Lens |
| 1(2^{nd} Area) | 1.018 | | | |
| 2 | −1.866 | 0.36 | | |
| 3 | ∞ | 0.60 | 1.62231 | Optical Disc D2 |
| 4 | ∞ | — | | |

TABLE 9

| | Surface No. | | |
|---|---|---|---|
| | 1(1^{st} Area) | 1(2^{nd} Area) | 2 |
| K | −1.8000 | −1.8000 | −34.0000 |
| A4 | 1.5691E−01 | 1.5691E−01 | 3.3546E−01 |
| A6 | −2.3053E−02 | −2.3053E−02 | −7.4755E−01 |
| A8 | 2.6193E−02 | 2.6193E−02 | 1.0563E+00 |
| A10 | −1.1620E−02 | −1.1620E−02 | −1.0805E+00 |
| A12 | 2.7747E−03 | 2.7747E−03 | 8.8310E−01 |
| A14 | 4.5118E−03 | 4.5118E−03 | −7.8443E−01 |
| A16 | −1.8948E−03 | −1.8948E−03 | 6.9730E−01 |
| A18 | −1.3785E−03 | −1.3785E−03 | −3.9771E−01 |
| A20 | 2.5463E−04 | 2.5463E−04 | 9.6521E−02 |
| A22 | 5.2523E−04 | 5.2523E−04 | −3.2092E−04 |
| A24 | −3.6517E−05 | −3.6517E−05 | −2.5861E−04 |
| A26 | −8.8387E−05 | −8.8387E−05 | 0.0000E+00 |

Then, optical path difference function coefficients Pₙ of the optical path difference function φ(h) for defining the annular zone structure of each area on the first surface 11 are shown in Table 10.

TABLE 10

Surface No.

| | 1(1^{st} Area) | 1(2^{nd} Area) |
|---|---|---|
| P2 | 1.0000E+02 | 0.0000E+00 |
| P4 | −8.7685E+00 | 0.0000E+00 |
| P6 | 1.2704E+01 | 0.0000E+00 |
| P8 | −1.1929E+01 | 0.0000E+00 |
| P10 | 8.8810E+00 | 0.0000E+00 |
| P12 | −2.5833E+00 | 0.0000E+00 |

As in the case of the first example, the annular zone structure is provided only in the first area 11a of the first surface 11 of the objective lens 10 according to the second example (see Table 10), and the second area 11b has an aspherical shape without the annular zone structure. The annular zone structure in the first area 11a has steps which are defined by one type of optical path difference function, and is designed to converge the 0-th order diffracted light (i=0) onto the recording surface of the optical disc D1, and to converge the first-order diffracted light (j=1) onto the recording surface of the optical disc D2. The second area 11b is designed to converge the incident beam onto the recording surface of the optical disc D1 through the effect of the aspherical shape.

In the second example, a value of the expression according to the condition (1) and the condition (2) are 775. Therefore, both of the conditions (1) and (2) are satisfied. By satisfying the conditions (1) and (2), the objective lens 10 according to the second example is able to form a spot where the spherical aberration is suitably corrected onto the recording surface of each of the optical discs D1 and D2, while achieving the excellent off-axis property in use of the optical disc D2. Therefore, it becomes possible to ensure the information recording or reproducing with a high degree of accuracy for each of the optical discs D1 and D2 which have low tolerance to aberration.

In the second example, a value of the expression according to each of the conditions (3) and (5) is 0.50, and therefore both of the conditions (3) and (5) are satisfied. By satisfying the conditions (3) and (5), the objective lens 10 according to the second example is able to secure a high use efficiency of light for each of the optical discs D1 and D2. Consequently, it becomes possible to ensure the information recording and reproducing with a high degree of accuracy for each of the optical discs D1 and D2.

In the second example, a value of the expression according to the condition (7) is 0.46, and therefore the condition (7) is satisfied. By satisfying the condition (7), the objective lens 10 is able to secure a high use efficiency of light for each of the optical discs D1 and D2. Therefore, further assurance of a proper operation can be achieved for each of the optical discs D1 and D2.

FIG. 5A is a graph showing the spherical aberration SA and the “offence against the sine condition” SC caused when the optical disc D1 is used in a design standard condition of the optical information recording/reproducing device 100 according to the second example. FIG. 5B is a graph showing the spherical aberration SA and the “offence against sine condition” SC caused when the optical disc D2 is used in the design standard condition of the optical information recording/reproducing device 100 according to the second example.

According to FIGS. 5A and 5B, it is understood that the spherical aberration is suitably corrected and the suitable off-axis property is achieved for each of the optical discs D1 and D2. Therefore, according to the second example, it is possible to ensure the information recording and reproducing with a high degree of accuracy for each of the optical discs D1 and D2.

Further, in the second example, the use efficiency of light in use of the optical disc D1 is 60%, and the use efficiency of light in use of the optical disc D2 is 40%. Although the use efficiency of light for the optical disc D1 is slightly lower than that in the first example, the use efficiency of light for the optical disc D1 is still maintained at a high level. These values of the use efficiency of light are enough for ensuring the information recording or reproducing with a high degree of accuracy for each of the optical discs D1 and D2. As described above, the objective lens 10 according to the second example exhibits an excellent optical property for the information recording or reproducing for each of the optical discs D1 and D2.

### Third Example

Hereafter, a third example is explained. The specifications of the objective lens 10 according to the third example are shown in Table 11, the specific numerical configurations in use of the respective optical discs D1 and D2 are respectively shown in Tables 12 and 13, and the respective coefficients which define the aspherical shape are shown in Table 14.

TABLE 11

| | Optical Disc D1 | Optical Disc D2 |
|---|---|---|
| Wavelength λ (nm) | 405 | 405 |
| Focal Length f (mm) | 1.65 | 1.71 |
| NA | 0.85 | 0.65 |
| Magnification | 0.000 | 0.000 |

TABLE 12

| Surface No. | r | d | n(405 nm) | |
|---|---|---|---|---|
| 1(1^{st} Area) | 1.164 | 1.83 | 1.65098 | Objective Lens |
| 1(2^{nd} Area) | 1.164 | | | |
| 2 | −5.287 | 0.57 | | |
| 3 | ∞ | 0.0875 | 1.62231 | Optical Disc D1 |
| 4 | ∞ | — | | |

TABLE 13

| Surface No. | r | d | n(405 nm) | |
|---|---|---|---|---|
| 1(1^{st} Area) | 1.164 | 1.83 | 1.65098 | Objective Lens |
| 1(2^{nd} Area) | 1.164 | | | |
| 2 | −5.287 | 0.33 | | |
| 3 | ∞ | 0.60 | 1.62231 | Optical Disc D2 |
| 4 | ∞ | — | | |

TABLE 14

| | Surface No. | | |
|---|---|---|---|
| | 1(1^{st} Area) | 1(2^{nd} Area) | 2 |
| K | −0.6500 | −0.6500 | −200.0000 |
| A4 | 1.7942E−02 | 1.7942E−02 | 2.0280E−01 |
| A6 | 2.5424E−03 | 2.5424E−03 | −4.4304E−01 |
| A8 | 8.8642E−03 | 8.8642E−03 | 7.9290E−01 |
| A10 | −7.8979E−03 | −7.8979E−03 | −1.0716E+00 |
| A12 | 8.0842E−04 | 8.0842E−04 | 1.0222E+00 |
| A14 | 4.9601E−03 | 4.9601E−03 | −8.0952E−01 |
| A16 | −1.7883E−03 | −1.7883E−03 | 6.0426E−01 |
| A18 | −1.6004E−03 | −1.6004E−03 | −3.6017E−01 |
| A20 | 4.4458E−04 | 4.4458E−04 | 1.2944E−01 |
| A22 | 8.2510E−04 | 8.2510E−04 | −1.9792E−02 |
| A24 | −4.9151E−04 | −4.9151E−04 | 0.0000E+00 |
| A26 | 7.4811E−05 | 7.4811E−05 | 0.0000E+00 |

Then, optical path difference function coefficients Pₙ of the optical path difference function φ(h) for defining the annular zone structure of each area on the first surface 11 are shown in Table 15.

TABLE 15

Surface No.

| | 1(1^{st} Area) | 1(2^{nd} Area) |
|---|---|---|
| P2 | 3.0000E+01 | 0.0000E+00 |
| P4 | −5.0620E+00 | 0.0000E+00 |
| P6 | 2.1194E−02 | 0.0000E+00 |
| P8 | −1.9451E+00 | 0.0000E+00 |
| P10 | 8.4951E−01 | 0.0000E+00 |
| P12 | −3.8320E−01 | 0.0000E+00 |

As in the case of the first example, the annular zone structure is provided only in the first area 11a of the first surface 11 of the objective lens 10 according to the third example (see Table 15), and the second area 11b has an aspherical shape without the annular zone structure. The annular zone structure in the first area 11a has steps which are defined by one type of optical path difference function, and is designed to converge the 0-th order diffracted light (i=0) onto the recording surface of the optical disc D1, and to converge the first-order diffracted light (j=1) onto the recording surface of the optical disc D2. The second area 11b is designed to converge the incident beam onto the recording surface of the optical disc D1 through the effect of the aspherical shape.

In the third example, a value of the expression according to the condition (1) and the condition (2) are 719. Therefore, both of the conditions (1) and (2) are satisfied. By satisfying the conditions (1) and (2), the objective lens 10 according to the third example is able to form a spot where the spherical aberration is suitably corrected onto the recording surface of each of the optical discs D1 and D2, while achieving the excellent off-axis property in use of the optical disc D2. Therefore, it becomes possible to ensure the information recording or reproducing with a high degree of accuracy for each of the optical discs D1 and D2 which have low tolerance to aberration.

In the third example, a value of the expression according to each of the conditions (3) and (5) is 0.40, and therefore both of the conditions (3) and (5) are satisfied. By satisfying the conditions (3) and (5), the objective lens 10 according to the third example is able to secure a high use efficiency of light for each of the optical discs D1 and D2. Consequently, it becomes possible to ensure the information recording and reproducing with a high degree of accuracy for each of the optical discs D1 and D2.

In the third example, a value of the expression according to the condition (7) is 0.32, and therefore the condition (7) is satisfied. By satisfying the condition (7), the objective lens 10 is able to secure a high use efficiency of light for each of the optical discs D1 and D2. Therefore, further assurance of a proper operation can be achieved for each of the optical discs D1 and D2.

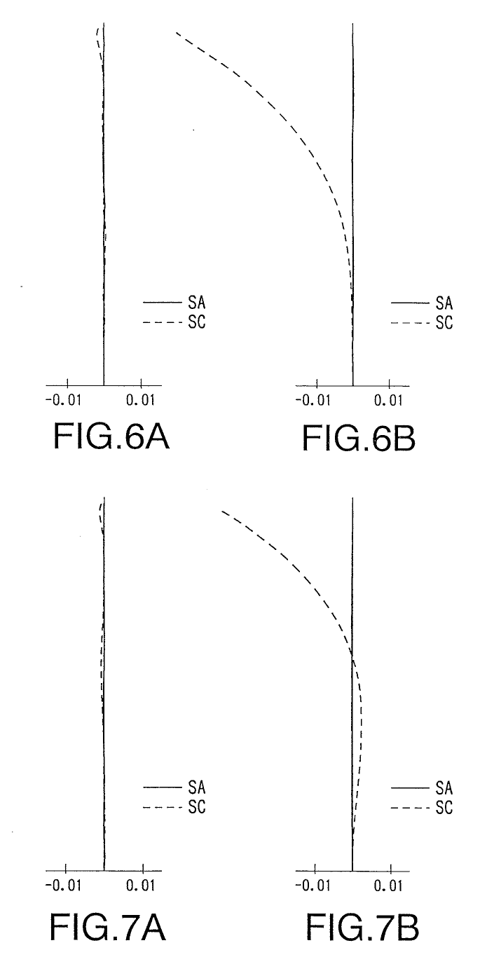

FIG. 6A is a graph showing the spherical aberration SA and the “offence against the sine condition” SC caused when the optical disc D1 is used in a design standard condition of the optical information recording/reproducing device 100 according to the third example. FIG. 6B is a graph showing the spherical aberration SA and the “offence against sine condition” SC caused when the optical disc D2 is used in the design standard condition of the optical information recording/reproducing device 100 according to the third example.

According to FIGS. 6A and 6B, it is understood that the spherical aberration is suitably corrected and the suitable off-axis property is achieved for each of the optical discs D1 and D2. Therefore, according to the third example, it is possible to ensure the information recording and reproducing with a high degree of accuracy for each of the optical discs D1 and D2.

Further, in the third example, the use efficiency of light in use of the optical disc D1 is 72%, and the use efficiency of light in use of the optical disc D2 is 25%. Although the use efficiency of light for the optical disc D2 is slightly lower than that in each of the first and second examples, the use efficiency of light for the optical disc D2 is still enough for the information recording and reproducing with a high degree of accuracy. That is, a high use efficiency of light can be secured for each of the optical disc D1 and D2. As described above, the objective lens 10 according to the third example exhibits an excellent optical property for the information recording or reproducing for each of the optical discs D1 and D2.

### Fourth Example

Hereafter, a fourth example is explained. The specifications of the objective lens 10 according to the fourth example are shown in Table 16, the specific numerical configurations in use of the respective optical discs D1 and D2 are respectively shown in Tables 17 and 18, and the respective coefficients which define the aspherical shape are shown in Table 19.

TABLE 16

| | Optical Disc D1 | Optical Disc D2 |
|---|---|---|
| Wavelength λ (nm) | 405 | 405 |
| Focal Length f (mm) | 1.53 | 1.57 |
| NA | 0.85 | 0.65 |
| Magnification | 0.000 | 0.000 |

TABLE 17

| Surface No. | r | d | n(405 nm) | |
|---|---|---|---|---|
| 1(1^{st} Area) | 0.978 | 1.86 | 1.56023 | Objective Lens |
| 1(2^{nd} Area) | 0.978 | | | |
| 2 | −1.845 | 0.48 | | |
| 3 | ∞ | 0.0875 | 1.62231 | Optical Disc D1 |
| 4 | ∞ | — | | |

TABLE 18

| Surface No. | r | d | n(405 nm) | |
|---|---|---|---|---|
| 1(1^{st} Area) | 0.978 | 1.86 | 1.56023 | Objective Lens |
| 1(2^{nd} Area) | 0.978 | | | |
| 2 | −1.845 | 0.22 | | |
| 3 | ∞ | 0.60 | 1.62231 | Optical Disc D2 |
| 4 | ∞ | — | | |

TABLE 19

| | Surface No. | | |
|---|---|---|---|
| | 1(1^{st} Area) | 1(2^{nd} Area) | 2 |
| K | −1.9200 | −1.9200 | −41.0000 |
| A4 | 1.8400E−01 | 1.8400E−01 | 2.9439E−01 |
| A6 | −4.5960E−02 | −4.5960E−02 | −6.1545E−01 |
| A8 | 4.5183E−02 | 4.5183E−02 | 9.3998E−01 |
| A10 | −3.0820E−02 | −3.0820E−02 | −1.1085E+00 |
| A12 | 1.3248E−02 | 1.3248E−02 | 9.4959E−01 |
| A14 | 5.0854E−03 | 5.0854E−03 | −7.5673E−01 |
| A16 | −4.2651E−03 | −4.2651E−03 | 6.2852E−01 |
| A18 | −2.4545E−03 | −2.4545E−03 | −3.6635E−01 |
| A20 | 1.1011E−03 | 1.1011E−03 | 9.1775E−02 |
| A22 | 1.2293E−03 | 1.2293E−03 | 0.0000E+00 |
| A24 | −5.9362E−04 | −5.9362E−04 | 0.0000E+00 |
| A26 | 0.0000E+00 | 0.0000E+00 | 0.0000E+00 |

Then, optical path difference function coefficients Pₙ of the optical path difference function φ(h) for defining the annular zone structure of each area on the first surface 11 are shown in Table 20.

TABLE 20

Surface No.

| | 1(1^{st} Area) | 1(2^{nd} Area) |
|---|---|---|
| P2 | 3.0000E+01 | 3.0000E+01 |
| P4 | −8.2467E+00 | −8.2467E+00 |
| P6 | 1.6629E+00 | 1.6629E+00 |
| P8 | −6.5088E+00 | −6.5088E+00 |
| P10 | 3.9902E+00 | 3.9902E+00 |
| P12 | −1.6125E+00 | −1.6125E+00 |

In the fourth example, the annular zone structure is provided both in the first area 11a and the second area 11b of the first surface 11 of the objective lens 10 (see Table 20). The annular zone structure in the first area 11a has steps which are defined by one type of optical path difference function, and is designed to converge the 1^{st}-order diffracted light (i=1) onto the recording surface of the optical disc D1, and to converge the second-order diffracted light (j=2) onto the recording surface of the optical disc D2. The annular zone structure in the second area 11b has steps which are defined by one type of optical path difference function, and is designed to converge the 1^{st}-order diffracted light onto the recording surface of the optical disc D1, and not to converge any orders of diffracted light onto the recording surface of the optical disc D2. Although the annular zone structures in the first and second areas 11a and 11b are defined by the same optical path difference function in the fourth example, the annular zone structures in the first and second areas 11a and 11b may be defined by optical path difference functions different from each other.

In the fourth example, a value of the expression according to the condition (1) and the condition (2) are 639. Therefore, the condition (1) is satisfied. By satisfying the condition (1), the objective lens 10 according to the fourth example is able to form a spot where the spherical aberration is suitably corrected onto the recording surface of each of the optical discs D1 and D2, while achieving the excellent off-axis property in use of the optical disc D2. Therefore, it becomes possible to ensure the information recording or reproducing with a high degree of accuracy for each of the optical discs D1 and D2 which have low tolerance to aberration.

In the fourth example, a value of the expression according to each of the conditions (3) and (5) is 1.43, and therefore both of the conditions (3) and (5) are satisfied. By satisfying the conditions (3) and (5), the objective lens 10 according to the fourth example is able to secure a high use efficiency of light for each of the optical discs D1 and D2. Even if the mode hop occurs with respect to the wavelength of the laser beam being used, it is possible to suppress fluctuation of the spherical aberration while maintaining the use efficiency of light at a high level.

In the fourth example, a value of the expression according to the condition (7) is 0.39, and therefore the condition (7) is satisfied. By satisfying the condition (7), the objective lens 10 is able to secure a high use efficiency of light for each of the optical discs D1 and D2. Therefore, further assurance of a proper operation can be achieved for each of the optical discs D1 and D2.

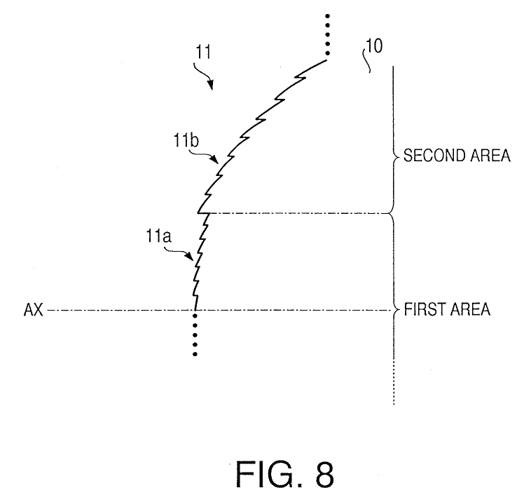

FIG. 7A is a graph showing the spherical aberration SA and the “offence against the sine condition” SC caused when the optical disc D1 is used in a design standard condition of the optical information recording/reproducing device 100 according to the fourth example. FIG. 7B is a graph showing the spherical aberration SA and the “offence against sine condition” SC caused when the optical disc D2 is used in the design standard condition of the optical information recording/reproducing device 100 according to the fourth example.

According to FIGS. 7A and 7B, it is understood that the spherical aberration is suitably corrected and the suitable off-axis property is achieved for each of the optical discs D1 and D2. Therefore, according to the fourth example, it is possible to ensure the information recording and reproducing with a high degree of accuracy for each of the optical discs D1 and D2.

Further, in the fourth example, the use efficiency of light in use of the optical disc D1 is 67%, and the use efficiency of light in use of the optical disc D2 is 30%. According to the fourth example, a high use efficiency of light can be secured for each of the optical disc D1 and D2. As described above, the objective lens 10 according to the fourth example exhibits an excellent optical property for the information recording or reproducing for each of the optical discs D1 and D2.

Although the present invention has been described in considerable detail with reference to certain preferred embodiments thereof, other embodiments are possible.

In the above described embodiment, the annular zone structure is formed only on the first surface 11 of the objective lens 10. However, the annular zone structure may be formed on both of the first surface 11 and the second surface 12. The annular zone structure may be formed at least a part on the second surface 12.

In the above described embodiment, the annular zone structure is defined by a single type of optical path difference function. However, the annular zone structure may be defined by combining a plurality of types of optical path difference functions. For example, by combining two types of optical path difference functions, the annular zone structure is provided with two types of steps which hive two different types of optical effects on the incident beam. The annular zone structure thus configured to have combined optical effects is able to a more suitable beam spot.

Still further, in the optical information recording/reproducing device 100, NA of the objective lens 10 in use of the optical disc D2 having a protective layer thickness of 0.6 mm may be suitably adjusted depending on the recording density, without limiting to the values described in the above described examples. For example, when DVD or an optical disc (e.g., DVD±R) having an equivalent recording density to DVD is assumed as the optical disc D2, NA of the objective lens 10 may be designed to be 0.4. In this case, even though the light source to be used for information recording or reproducing for each of the optical discs D1 and D2 is a single light source for emitting only a light beam of approximately 405 nm wavelength, the optical information recording/reproducing device 100 is able to have compatibility with BD and DVD.

This application claims priority of Japanese Patent Application No. P2008-100252, filed on Apr. 8, 2008. The entire subject matter of the application is incorporated herein by reference.

What is claimed is:

1. A multifocal objective lens used for an optical information recording/reproducing device for recording information to and/or reproducing information from at least two types of optical discs including a first optical disc and a second optical disc having a recording density lower than that of the first optical disc, by using a light beam having a same wavelength of λ for the first and second optical discs,
when protective layer thicknesses of the first and second optical discs are defined as t1 (mm) and t2 (mm), respectively, the protective layer thicknesses t1 and t2 having a following relationship:
t1<t2,
at least one surface of the multifocal objective lens comprising:
a first area configured to contribute to converging i-th order diffracted light of the light beam onto a recording surface of the first optical disc and converging j-th order diffracted light onto a recording surface of the second optical disc,
the first area including a step structure having a plurality of refractive surface zones concentrically formed about a predetermined axis,
the step structure in the first area including at least a single type of step group giving an optical path length difference with respect to an incident light beam between adjacent ones of the plurality of refractive surface zones,
the step structure being defined by an optical path difference function φ(h):
φ(h)=(P₂h²+P₄h⁴+P₆h⁶+P₈h⁸+P₁₀h¹⁰+P₁₂h¹²)jλ
where P₂, P₄, P₆ represent coefficients of the 2^{nd} order, 4^{th} order, 6^{th} order, respectively, h represents a height from an optical axis, and j is defined by i+1,
the multifocal objective lens satisfying a condition:
$$630 < \frac{P 2}{t 2 - t 1} + 110 \times f 1 + 735 \times ( n - 1 ) < 800 \qquad ( 1 )$$
where n represents an refractive index of the multifocal objective lens with respect to the wavelength λ, and f1 (mm) represents a focal length of the multifocal objective lens with respect to the first optical disc.

2. The multifocal objective lens according to claim 1, wherein the multifocal objective lens further satisfies a condition:
$$670 < \frac{P 2}{t 2 - t 1} + 110 \times f 1 + 735 \times ( n - 1 ) < 780. \qquad ( 2 )$$

3. The multifocal objective lens according to claim 1, wherein the multifocal objective lens further satisfies conditions:
$$\begin{matrix}{N}_{1} - 0.75 < \vert \frac{d \times ( n - 1 )}{λ} \vert < {N}_{1} - 0.15 ; \\ and & ( 3 ) \\ 3.9 \times {10}^{- 4} < λ < 4.2 \times {10}^{- 4} & ( 4 )\end{matrix}$$
where d (mm) represents an average height of the step group, and N₁ represents a natural number.

4. The multifocal objective lens according to claim 3, wherein the multifocal objective lens further satisfies a condition:
$${N}_{1} - 0.70 < \vert \frac{d \times ( n - 1 )}{λ} \vert < {N}_{1} - 0.40 . \qquad ( 5 )$$

5. The multifocal objective lens according to claim 1, wherein the multifocal objective lens further satisfies a condition:
1.50≦n≦1.66 (6).

6. The multifocal objective lens according to claim 1, wherein an optical disc side surface of the multifocal objective lens is configured such that a sign of curvature changes within an effective diameter.

7. The multifocal objective lens according to claim 1,
wherein:
the at least one surface of the multifocal objective lens has a second area located outside the first area; and
the second area is configured to contribute to converging the light beam onto the recording surface of the first optical disc and not to contribute to converging the light beam onto the recording surface of the second optical disc.

8. The multifocal objective lens according to claim 7,
wherein the at least one surface of the multifocal objective lens is configured to satisfy a condition:
0.2×10⁻³<d1−d2<1.0×10³ (7)
where d1 (mm) represents a height of a step formed at an outermost part in the first area, and d2 (mm) represents a height of a step formed at an innermost part in the second area 11b.

9. The multifocal objective lens according to claim 7, wherein the second area is formed to be a refractive surface.

10. An optical information recording/reproducing device for recording information to and/or reproducing information from at least two types of optical discs including a first optical disc and a second optical disc having a recording density lower than that of the first optical disc, by using a light beam having a same wavelength of λ for the first and second optical discs,
when protective layer thicknesses of the first and second optical discs are defined as t1 (mm) and t2 (mm), respectively, the protective layer thicknesses t1 and t2 having a following relationship:
t1<t2,
the optical information recording/reproducing device comprising a multifocal objective lens,
at least one surface of the multifocal objective lens comprising:
a first area configured to contribute to converging i-th order diffracted light of the light beam onto a recording surface of the first optical disc and converging j-th order diffracted light onto a recording surface of the second optical disc,
the first area including a step structure having a plurality of refractive surface zones concentrically formed about a predetermined axis,
the step structure in the first area including at least a single type of step group giving an optical path length difference with respect to an incident light beam between adjacent ones of the plurality of refractive surface zones,
the step structure being defined by an optical path difference function φ(h):
φ(h)=(P₂h²+P₄h⁴+P₆h⁶+P₈h⁸+P₁₀h¹⁰+P₁₂h¹²)jλ
where P₂, P₄, P₆ . . . represent coefficients of the 2^{nd} order, 4^{th} order, 6^{th} order, respectively, h represents a height from an optical axis, and j is defined by i+1,
the multifocal objective lens satisfying a condition:
$$630 < \frac{P 2}{t 2 - t 1} + 110 \times f 1 + 735 \times ( n - 1 ) < 800 \qquad ( 1 )$$
where n represents an refractive index of the multifocal objective lens with respect to the wavelength λ, and f1 (mm) represents a focal length of the multifocal objective lens with respect to the first optical disc.

11. The optical information recording/reproducing device according to claim 10, wherein the multifocal objective lens further satisfies a condition:
$$670 < \frac{P 2}{t 2 - t 1} + 110 \times f 1 + 735 \times ( n - 1 ) < 780. \qquad ( 2 )$$

12. The optical information recording/reproducing device lens according to claim 10, wherein the multifocal objective lens further satisfies conditions:
$$\begin{matrix}{N}_{1} - 0.75 < \vert \frac{d \times ( n - 1 )}{λ} \vert < {N}_{1} - 0.15 ; \\ and & ( 3 ) \\ 3.9 \times {10}^{- 4} < λ < 4.2 \times {10}^{- 4} & ( 4 )\end{matrix}$$
where d (mm) represents an average height of the step group, and N₁ represents a natural number.

13. The optical information recording/reproducing device according to claim 12, wherein the multifocal objective lens further satisfies a condition:
$${N}_{1} - 0.70 < \vert \frac{d \times ( n - 1 )}{λ} \vert < {N}_{1} - 0.40 . \qquad ( 5 )$$

14. The optical information recording/reproducing device according to claim 10, wherein the multifocal objective lens further satisfies a condition:
1.50≦n≦1.66 (6).

15. The optical information recording/reproducing device according to claim 10, wherein an optical disc side surface of the multifocal objective lens is configured such that a sign of curvature changes within an effective diameter.

16. The optical information recording/reproducing device according to claim 10, wherein:
the at least one surface of the multifocal objective lens has a second area located outside the first area; and
the second area is configured to contribute to converging the light beam onto the recording surface of the first optical disc and not to contribute to converging the light beam onto the recording surface of the second optical disc.

17. The optical information recording/reproducing device according to claim 16, wherein the at least one surface of the multifocal objective lens is configured to satisfy a condition:
0.2×10⁻³<d1−d2<1×10⁻³ (7)
where d1 (mm) represents a height of a step formed at an outermost part in the first area, and d2 (mm) represents a height of a step formed at an innermost part in the second area 11b.

18. The optical information recording/reproducing device according to claim 16, wherein the second area is formed to be a refractive surface.
